(19) United States
(12) Patent Application Publication
(10) Pub. No.: US 2014/0372916 A1
(43) Pub. Date: Dec. 18, 2014

(54) FIXED HEADER CONTROL FOR GROUPED GRID PANEL

(71) Applicant: Microsoft Corporation, Redmond, WA (US)

(72) Inventors: Julien Dollon, Bellevue, WA (US); Sarah G. Williams, Seattle, WA (US)

(21) Appl. No.: 13/915,637

(22) Filed: Jun. 12, 2013

(51) Int. Cl. G06F 3/0482; G06F 3/0485

(52) U.S. Cl. CPC G06F 3/0482; G06F 3/0485
USPC 715/765

(57) ABSTRACT

In one embodiment, a graphical user interface 200 may keep an active header 304 present in the view frame 220 while scrolling through an active display item set 302, with smooth transitions between headers 214. The graphical user interface 200 for an operating system of the user device may display an active display item set 302 in a grid view. The graphical user interface 200 may automatically adjust a dependent scrolling motion animation of the active display item set 302 based on the form factor of the user device.

### BACKGROUND

A user device may have an operating system that presents a graphical user interface. The graphical user interface may represent an application or data file on the system as a display item. The display item may be an icon or an interactive tile that presents information about the application or data file. A user may manipulate a display item relative to a background and other display items presented by the graphical user interface.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Embodiments discussed below relate to keeping an active header present in the view frame while scrolling through an active display item set, with smooth transitions between headers. The graphical user interface for an operating system of the user device may display an active display item set in a grid view. The graphical user interface may automatically adjust a dependent scrolling motion animation of the active display item set based on the form factor of the user device.

### DRAWINGS

In order to describe the manner in which the above-recited and other advantages and features can be obtained, a more particular description is set forth and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates, in a block diagram, one embodiment of a computing device.

FIG. 2 illustrates, in a block diagram, one embodiment of a graphical user interface.

FIGS. 3a-c illustrate, in a block diagram, one embodiment of an interaction between display item sets.

FIG. 4 illustrates, in a software class model, one embodiment of a graphical user interface class.

FIG. 5 illustrates, in a flowchart, one embodiment of a method of displaying a graphical user interface.

FIG. 6 illustrates, in a flowchart, one embodiment of a method of displaying a display item set interaction.

FIG. 7 illustrates, in a flowchart, one embodiment of a method of displaying a graphical user interface.

### DETAILED DESCRIPTION

Embodiments are discussed in detail below. While specific implementations are discussed, it should be understood that this is done for illustration purposes only. A person skilled in the relevant art will recognize that other components and configurations may be used without parting from the spirit and scope of the subject matter of this disclosure. The implementations may be a machine-implemented method, a tangible machine-readable medium having a set of instructions detailing a method stored thereon for at least one processor, or a user device.

A graphical user interface of an operating system for a user device may present one or more display items to a user. A display item may be an icon, an interactive tile, a media file, a data file, or other visual representation. The graphical user interface may group the display items into one or more sets, based on common features. A header may describe each display item set to aid a user in locating a desired display item.

As a display item set may use more viewing space than is present in the display, the graphical user interface may show a fraction of the display item set while allowing the user to scroll through the display item set. The header for the display item set may be placed in a holding pattern while that display item set is presented. Once a user has scrolled to a new display item set, the header for that display item set may replace the previous header. Depending on the processing power and memory of the user device, more or less complex animation may be used to illustrate the scrolling motion to provide an aesthetic user experience. The scrolling motion may be animated by a dependent animation. A dependent animation depends on an outside factor, such as a user motion. A more complex animation of the dependent scrolling motion animation may be a push animation, with the incoming header pushing out the active header. A push animation may animate both the active header leaving the viewing space and the incoming header replacing the active header. A less complex animation of the dependent scrolling motion animation may be a slide under animation, with the incoming header sliding under the active header. A slide under animation animates the incoming header, with the active header disappearing once the incoming header is in place.

Application developers may use a customization of an established grid view class to code the headers to perform these animations. A grid view class presents the active display item set in a grid presentation. The header may be coded as a customized grid view item class. A grid view item class is an object in the grid view class. The grid view item may represent both a display item and a header for the display item set in the grid view item class format.

Further, by storing the header and the display item as a grid view item, the graphical user interface may allow the user to perform different scrolling motions to the display item set. For example, the user may snap the active display item set to a vertical scrolling motion, so that display items move in a vertical direction without any horizontal motion. Alternately, the user may snap the active display item set to a horizontal scrolling motion, so that display items move in a horizontal direction without any vertical motion.

Thus, in one embodiment, a graphical user interface may keep an active header present in the view frame while scrolling through an active display item set, with smooth transitions between headers. A graphical user interface for an operating system of a user device may represent an active header for an active display item set as a grid view item. The graphical user interface may display an active display item set in a grid view. The graphical user interface may execute a dependent scrolling motion animation of the active header relative to the active display item set using the grid view item. The graphical user interface may automatically adjust the dependent scrolling motion animation of the active display item set based on a form factor of the user device.

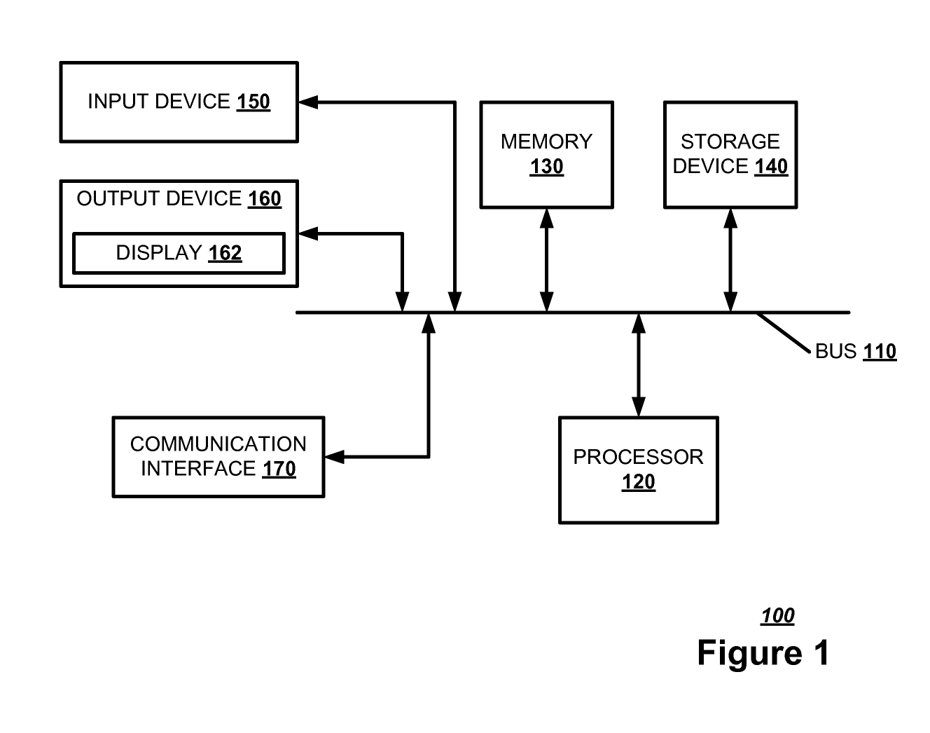

FIG. 1 illustrates a block diagram of an exemplary computing device 100 which may act as a user device. The computing device 100 may combine one or more of hardware, software, firmware, and system-on-a-chip technology to implement an operating system of a user device. The computing device 100 may include a bus 110, a processor 120, a memory 130, a data storage 140, an input device 150, an output device 160, and a communication interface 170. The bus 110, or other component interconnection, may permit communication among the components of the computing device 100.

The processor 120 may include at least one conventional processor or microprocessor that interprets and executes a set of instructions. The memory 130 may be a random access memory (RAM) or another type of dynamic data storage that stores information and instructions for execution by the processor 120. The memory 130 may also store temporary variables or other intermediate information used during execution of instructions by the processor 120. The data storage 140 may include a conventional ROM device or another type of static data storage that stores static information and instructions for the processor 120. The data storage 140 may include any type of tangible machine-readable medium, such as, for example, magnetic or optical recording media, such as a digital video disk, and its corresponding drive. A tangible machine-readable medium is a physical medium storing machine-readable code or instructions, as opposed to a signal. Having instructions stored on computer-readable media as described herein is distinguishable from having instructions propagated or transmitted, as the propagation transfers the instructions, versus stores the instructions such as can occur with a computer-readable medium having instructions stored thereon. Therefore, unless otherwise noted, references to computer-readable media/medium having instructions stored thereon, in this or an analogous form, references tangible media on which data may be stored or retained. The data storage 140 may store a set of instructions detailing a method that when executed by one or more processors cause the one or more processors to perform the method.

The input device 150 may include one or more conventional mechanisms that permit a user to input information to the computing device 100, such as a keyboard, a mouse, a voice recognition device, a microphone, a headset, a gesture recognition device, a touch screen, etc. The output device 160 may include one or more conventional mechanisms that output information to the user, including a display 162, a printer, one or more speakers, a headset, or a medium, such as a memory, or a magnetic or optical disk and a corresponding disk drive. The communication interface 170 may include any transceiver-like mechanism that enables computing device 100 to communicate with other devices or networks. The communication interface 170 may include a network interface or a transceiver interface. The communication interface 170 may be a wireless, wired, or optical interface.

The computing device 100 may perform such functions in response to processor 120 executing sequences of instructions contained in a computer-readable medium, such as, for example, the memory 130, a magnetic disk, or an optical disk. Such instructions may be read into the memory 130 from another computer-readable medium, such as the data storage 140, or from a separate device via the communication interface 170.

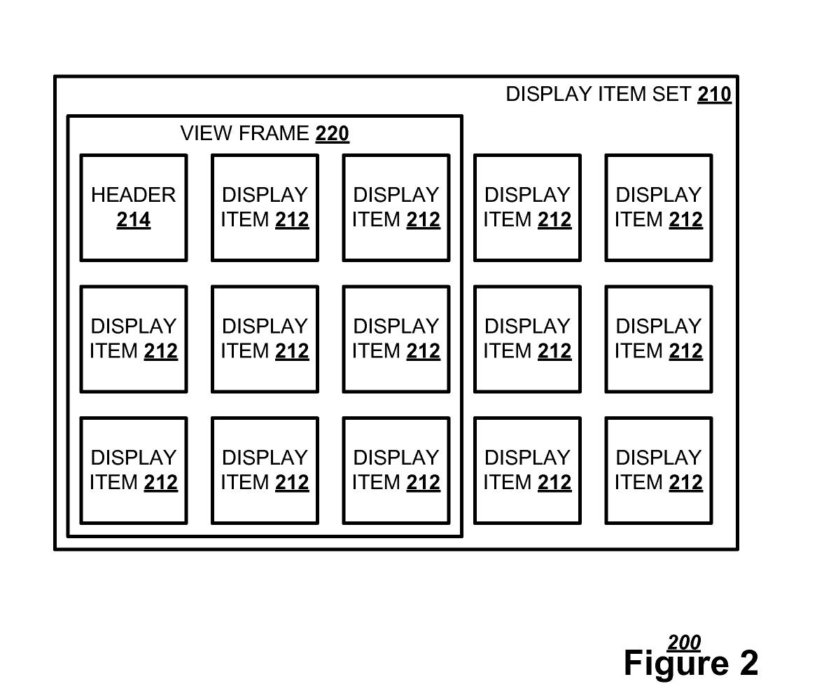

The operating system of the user may present a graphical user interface on the display 162. FIG. 2 illustrates, in a block diagram, one embodiment of a graphical user interface 200. The graphical user interface 200 may display a display item set 210 containing one or more display items 212. These display items may be icons, interactive tiles, media, or other graphical user interface objects that may be manipulated by a user. The display item set 210 may be grouped based on a common feature. For example, each display item 212 in the display item set 210 may be an interactive tile for media playing applications. The display item set 210 may have a header 214 describing the display items 212. In the above example, the header may be “Media Players”.

The layout of the graphical user interface 200 may prevent a display 162 from presenting the entire graphical user interface 200 to the user at one time. The display 162 may show a portion of the graphical user interface 200 in the viewing area, referred to herein as the view frame 220. The portion of the display item set 210 shown in the view frame 220 is the viewing subset. The user may scroll between the different display items 212 using a cursor input device, such as mouse, keyboard, touch screen, track pad, or gesture capture device. The graphical user interface 200 may place the header 214 in a holding pattern so that the header 214 remains in the view frame 220 as long as the display item set 210 is in the view frame 220.

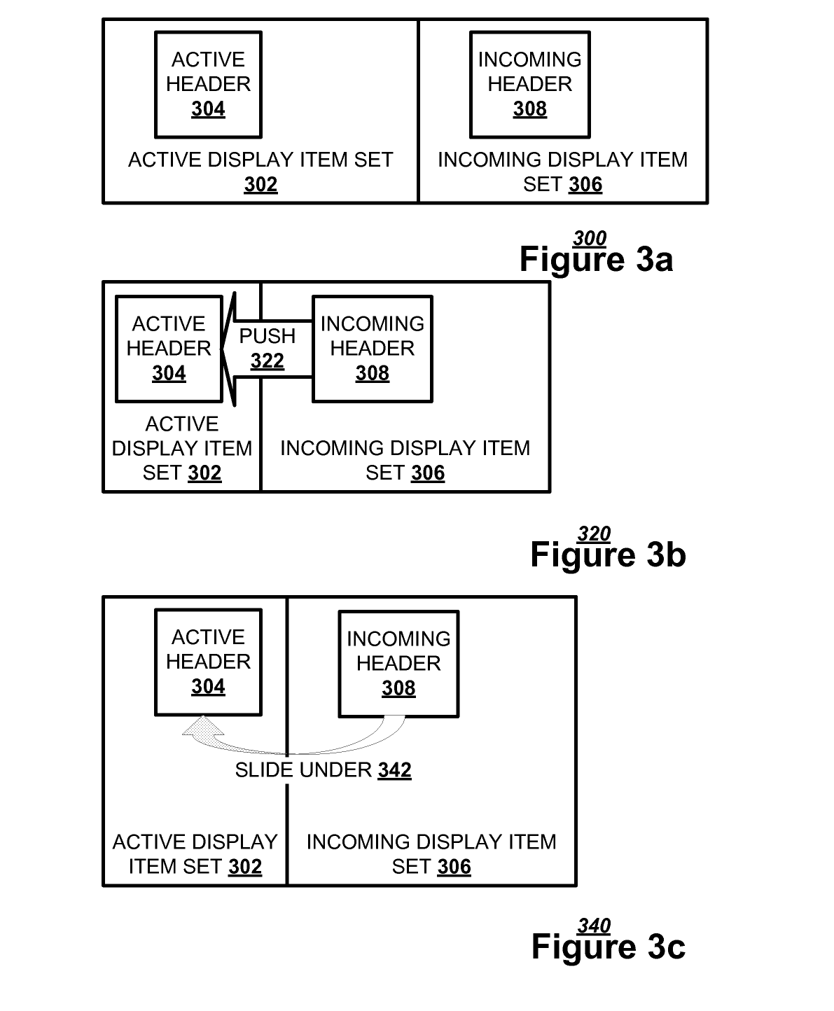

A graphical user interface 200 may have display items grouped into multiple display item sets 210. FIG. 3a illustrates, in a block diagram, one embodiment of an interaction 300 between display item sets. The display item set 210 currently the focus of the view frame 220 is the active display item set 302. A display item set 210 may have focus if that display item set 210 is closest to the initial literacy position. The initial literacy position in the United States may tend to be the upper left hand corner, as text is read from left to right and top to bottom. The active display item set 302 may have an active header 304, describing the active display item set 302. The active header 304 may be placed in a holding pattern within the view frame 220 while the active display item set 302 is present. A second display item set 210 moving towards the initial literacy position may be an incoming display item set 306. The incoming display item set 306 may have an incoming header 308. The incoming header 308 may replace the active header 304 as the active display item set 302 exits the view frame 220.

In a user device with sufficient processing power, the incoming header 308 may perform a push animation 320 with the active header 304. FIG. 3b illustrates, in a block diagram, one embodiment of a push animation 320. The incoming header 308 may push 322 against the active header 304. In a push interaction 320, the graphical user interface 200 may animate both the incoming header 308 and the active header 304. The graphical user interface 200 may animate the incoming header 308 to move towards the active header 304. The graphical user interface 200 may animate the active header 304 to move away from the incoming header 308. The graphical user interface 200 may use greater processing power as two headers 214 are animated.

In a user device with lesser processing power, the incoming header 308 may perform a slide under animation with the active header 304. FIG. 3c illustrates, in a block diagram, one embodiment of a slide under animation 340 between display item sets. The incoming header 308 may slide under 342 the active header 304. In a slide under animation 340, the graphical user interface 200 may animate the incoming header 308. The graphical user interface 200 may animate the incoming header 308 to move towards the active header 304 and slide under the active header 304. The active header 304 stays in place, closing once the incoming header 308 has reached the position of the active header 304. The graphical user interface 200 may use less processing power as just the incoming header 308 is animated.

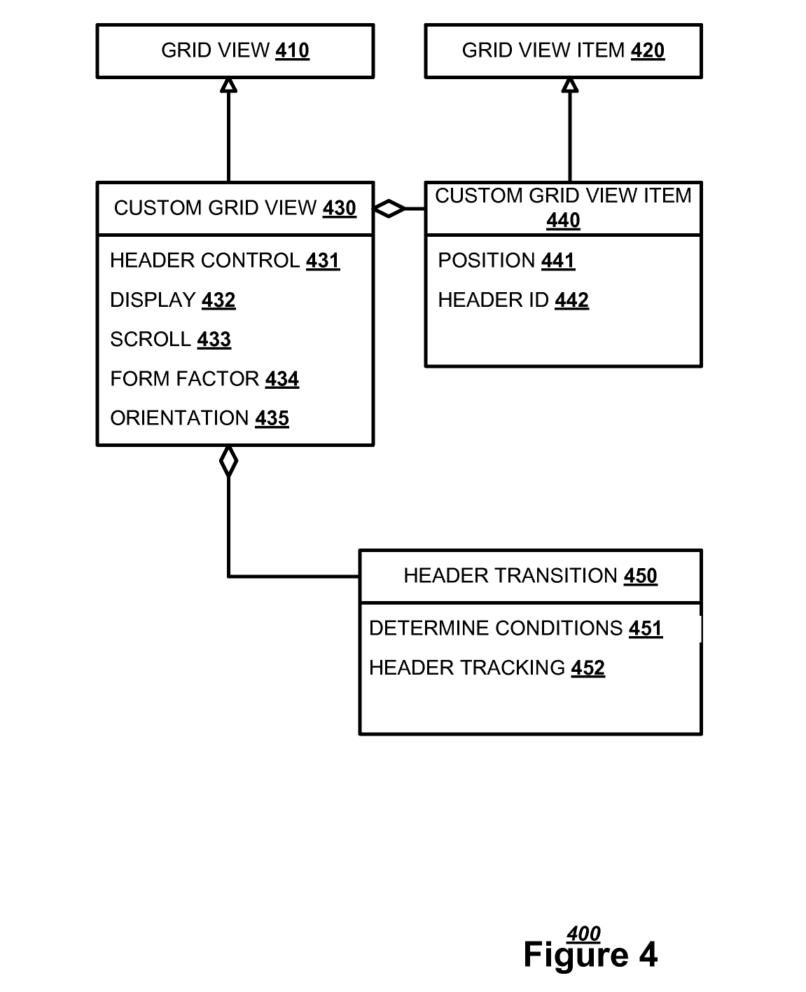

A developer of the graphical user interface may use a graphical user interface class to implement the display item set 210. The graphical user interface class may be developed using an implementation language, such as C++, extensible application markup language (XAML), or Windows Runtime®. FIG. 4 illustrates, in a software class model, one embodiment of a graphical user interface class 400. At a general level, the graphical user interface 200 may place the display item set 210 in a grid view using a grid view class 410. Each display item 212 may be coded as a grid view item class 420. More specifically, the display item set 210 may be coded as a custom grid view class 430, aggregating each display item 212 coded as a custom grid view item 440. Further, the custom grid view class 430 may aggregate one or more header transition classes 450.

The custom grid view class 430 may have additional functions to smoothly animate the transition between headers 214. The custom grid view class 430 may have one or more header control functions 431 to determine the active header 304. The custom grid view class 430 may have a display function 432 to display the custom grid view item 440. The custom grid view class 430 may have scroll function 433 to scroll between the custom grid view items 440. The custom grid view class 430 may have a form factor function 434 to determine the system capabilities provided by the user device. The custom grid view class 430 may have an orientation function 435 to determine the orientation of the user device, such as landscape or portrait.

The custom grid view item class 440 may have additional functions to smoothly animate the transition between headers 214. The custom grid view item class 440 may have a position function 441 to determine the position of the custom grid view item. The custom grid view item class 440 may have a header identifier function 442 to identify if the custom grid view item is a header.

The header transition class 450 may have additional functions to smoothly animate the transition between headers 214. The header transition class 450 may have a determine conditions function 451 to determine the optimum conditions for the header transition. The header transition class 450 may have one or more header tracking functions 452 to identify the previous, current and possible future headers.

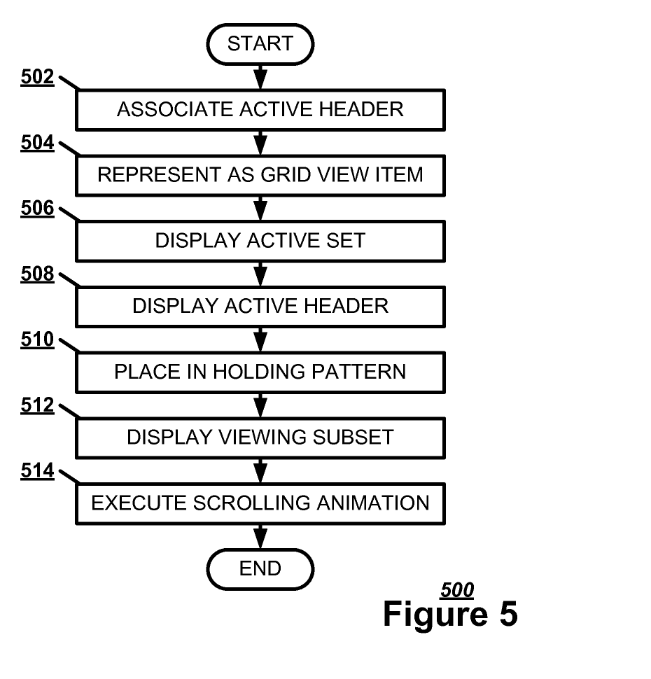

FIG. 5 illustrates, in a flowchart, one embodiment of a method 500 of displaying a graphical user interface 200. The graphical user interface 200 for an operating system of a user device may associate an active header 304 with the active display item set 302 (Block 502). The graphical user interface 200 may represent the active header 304 for the active display item set 302 as a grid view item (Block 504). The graphical user interface 200 may display the active display item set 302 in a grid view (Block 506). The graphical user interface 200 may display an active header 304 of the active display item set 302 in a view frame 220 (Block 508). The graphical user interface 200 may place the active header 304 of the active display item set 302 in a holding pattern in the view frame 220 as the active display item set 302 moves (Block 510). The graphical user interface 200 may display a viewing subset of the active display item set 302 in a view frame 220 (Block 512). The graphical user interface 200 may execute a dependent scrolling motion animation of the active header relative to the active display item set 312 using the grid view item functionality (Block 514).

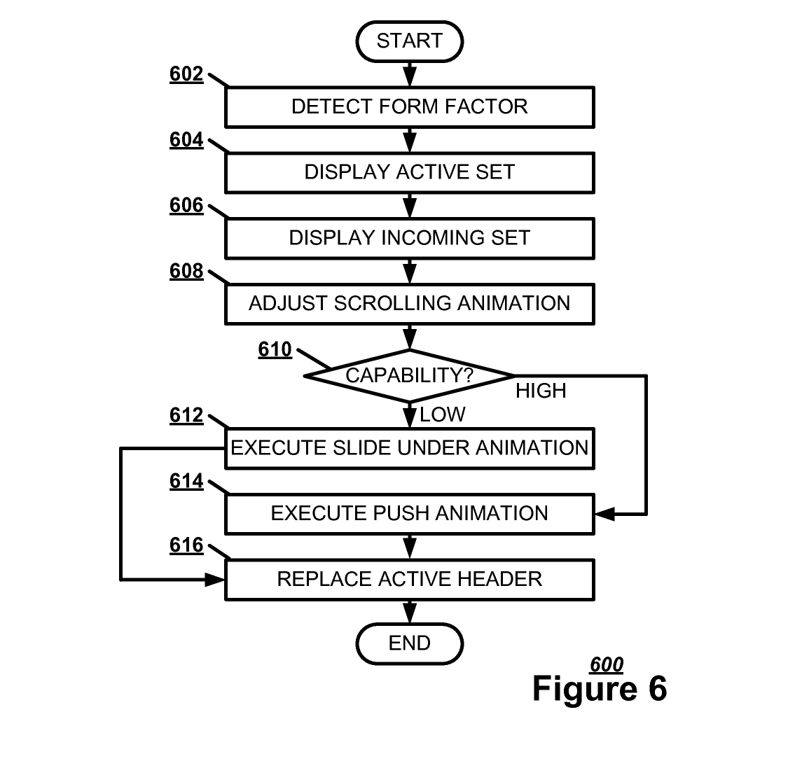

FIG. 6 illustrates, in a flowchart, one embodiment of a method 600 of displaying a display item set 210 interaction. The graphical user interface 200 of an operating system of a user device may detect a form factor for the user device upon loading an active display item set 302 (Block 602). The graphical user interface 200 may display an active display item set 302 in a grid view (Block 604). The graphical user interface 200 may display an incoming display item set 306 in a view frame 220 (Block 606). The graphical user interface 200 may automatically adjust a dependent scrolling motion animation of the active display item set 302 based on the form factor of the user device (Block 608). If the form factor indicates a low processing and memory capability (Block 610), the graphical user interface 200 may execute a slide under animation 340 to replace an active header 304 for the active display item set 302 with an incoming header 308 for an incoming display item set 306 (Block 612). If the form factor indicates a high processing and memory capability (Block 610), the graphical user interface 200 may execute a push animation 320 to replace an active header 304 for the active display item set 302 with an incoming header 308 for an incoming display item set 306 (Block 614). The graphical user interface 200 may replace the active header 304 for the active display item set 302 with an incoming header 308 for an incoming display item set 306 (Block 616).

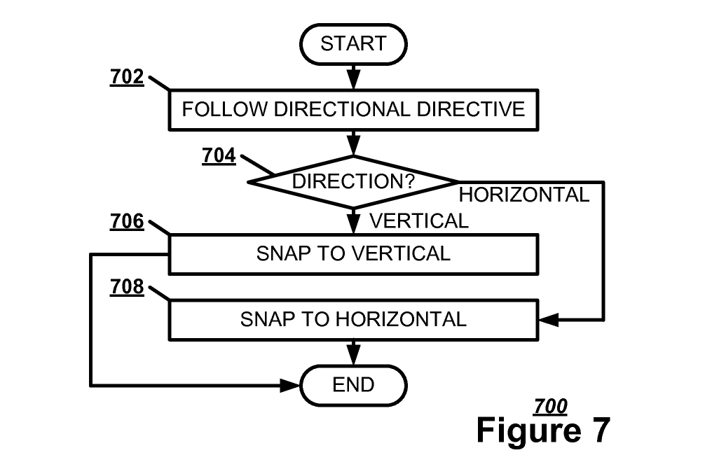

The user may snap the scrolling motion to either a horizontal or vertical motion. FIG. 7 illustrates, in a flowchart, one embodiment of a method 700 of displaying a graphical user interface. The graphical user interface 200 may follow a directional directive indicated by the developer (Block 702). If the directional directive indicates a vertical scrolling motion (Block 704), the graphical user interface 200 may snap the active display item set 302 to a vertical scrolling motion (Block 706). If the directional directive indicates a horizontal scrolling motion (Block 704), the graphical user interface 200 may snap the active display item set 302 to a horizontal scrolling motion (Block 708).

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Embodiments within the scope of the present invention may also include computer-readable storage media for carrying or having computer-executable instructions or data structures stored thereon. Such computer-readable storage media may be any available media that can be accessed by a general purpose or special purpose computer. By way of example, and not limitation, such computer-readable storage media can comprise RAM, ROM, EEPROM, CD-ROM or other optical disk storage, magnetic disk storage or other magnetic data storages, or any other medium which can be used to carry or store desired program code means in the form of computer-executable instructions or data structures. Combinations of the above should also be included within the scope of the computer-readable storage media.

Embodiments may also be practiced in distributed computing environments where tasks are performed by local and remote processing devices that are linked (either by hardwired links, wireless links, or by a combination thereof) through a communications network.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments are part of the scope of the disclosure. For example, the principles of the disclosure may be applied to each individual user where each user may individually deploy such a system. This enables each user to utilize the benefits of the disclosure even if any one of a large number of possible applications do not use the functionality described herein. Multiple instances of electronic devices each may process the content in various possible ways. Implementations are not necessarily in one system used by all end users. Accordingly, the appended claims and their legal equivalents should only define the invention, rather than any specific examples given.

We claim:

1. A machine-implemented method, comprising:
displaying an active display item set in a grid view in a graphical user interface for an operating system of a user device;
adjusting automatically a dependent scrolling motion animation of the active display item set based on a form factor of the user device.

2. The method of claim 1, further comprising:
associating an active header with the active display item set.

3. The method of claim 1, further comprising:
representing an active header of the active display item set as a grid view item.

4. The method of claim 1, further comprising:
displaying an active header of the active display item set in a view frame of the graphical user interface.

5. The method of claim 1, further comprising:
placing an active header of the active display item set in a holding pattern in a view frame of the graphical user interface as the active display item set moves.

6. The method of claim 1, further comprising:
displaying a viewing subset of the active display item set in a view frame of the graphical user interface.

7. The method of claim 1, further comprising:
displaying an incoming display item set in a view frame of the graphical user interface.

8. The method of claim 1, further comprising:
replacing an active header for the active display item set with an incoming header for an incoming display item set.

9. The method of claim 1, further comprising:
executing a push animation to replace an active header for the active display item set with an incoming header for an incoming display item set.

10. The method of claim 1, further comprising:
executing a slide under animation to replace an active header for the active display item set with an incoming header for an incoming display item set.

11. The method of claim 1, further comprising:
snapping the active display item set to at least one of a vertical scrolling motion and a horizontal scrolling motion.

12. A tangible machine-readable medium having a set of instructions detailing a method stored thereon that when executed by one or more processors cause the one or more processors to perform the method, the method comprising:
representing an active header for an active display item set in a graphical user interface for an operating systems of a user device as a grid view item;
displaying the active display item set in a grid view; and
executing a dependent scrolling motion animation of the active header relative to the active display item set using the grid view item.

13. The tangible machine-readable medium of claim 12, wherein the method further comprises:
adjusting automatically the dependent scrolling motion animation of the active display item set based on a form factor of the user device.

14. The tangible machine-readable medium of claim 12, wherein the method further comprises:
placing an active header of the active display item set in a holding pattern in a view frame of the graphical user interface as the active display item set moves.

15. The tangible machine-readable medium of claim 12, wherein the method further comprises:
replacing an active header for the active display item set with an incoming header for an incoming display item set.

16. The tangible machine-readable medium of claim 12, wherein the method further comprises:
executing a push animation to replace an active header for the active display item set with an incoming header for an incoming display item set.

17. The tangible machine-readable medium of claim 12, wherein the method further comprises:
executing a slide under animation to replace an active header for the active display item set with an incoming header for an incoming display item set.

18. The tangible machine-readable medium of claim 12, wherein the method further comprises:
snapping the active display item set to at least one of a vertical scrolling motion and a horizontal scrolling motion.

19. A tablet user device, comprising:
a display that presents an active display item set in a grid view in a graphical user interface for an operating systems;
a memory that represents an active header for the active display item set as a grid view item; and
a processor that automatically adjusts a dependent scrolling motion animation of the active display item set based on a form factor for the tablet user device.

20. The tablet user device of claim 19, wherein the processor snaps the active display item set to at least one of a vertical scrolling motion and a horizontal scrolling motion.
